(19) United States
(12) Patent Application Publication
(10) Pub. No.: US 2007/0088599 A1
(43) Pub. Date: Apr. 19, 2007

(54) Apparatus and method for analyzing new product performance

(75) Inventors: Brian A. Vulpitta, Avon Lake, OH (US); Andrew G. Wellener, Avon, OH (US)

Correspondence Address: Thomas E. Young, Esq.;Fay, Sharpe, Fagan, Minnich & McKee, LLP, Seventh Floor, 1100 Superior Avenue, Cleveland, OH, 44114-2579, US

(73) Assignee: Henkel Consumer Adhesives, Inc.

(21) Appl. No.: 11/252,484

(22) Filed: Oct. 18, 2005

(51) Int. Cl. G06F 17/30

(52) U.S. Cl. 705/10

(57) ABSTRACT

A business method manages items associated with a business entity. The business method includes storing item unique identifiers, associating each identifier with at least one descriptor that further describes the item, tracking a performance of each item through the at least one descriptor, analyzing the tracked performance of the item, and rendering business decisions about the item based on the analysis. The at least one descriptor relates to a predetermined reason for introducing an item into a market, the reason including at least one of the following: to create a new product/business line; to offer a new item for sale; to create a line extension of an existing product line; to create a customer-specific line extension of an existing product line; to offer a promotional item; to create a display item; to change packaging for an existing product; to modify an existing item; to create a component item, and to create an international item.

### BACKGROUND

The exemplary embodiments described herein relate to business methods. They find particular application in conjunction with using a business system to analyze product performance in order to assess and manage various aspects of product research, development, and business activities, and will be described with particular reference thereto. However, it is to be appreciated that the exemplary embodiments are also amenable to other like applications.

Early business management system solutions, i.e., circa 1985-1993, consisted of in-house solutions or material requirement planning and distribution requirement planning. These previous methods failed to use information technology to integrate supply chain management and financial management. They also failed to exploit significant opportunities to improve financial performances by not integrating the supply chain and financial business functions. The early to mid-1990's saw a move to business management systems that included bookkeeping, automating traditional functional activities, and data integration. The late 1990's saw a further move toward advanced planning systems, or supply chain management using more sophisticated and “intelligent” decision-support systems for different enterprise functions.

Products sold to consumers or through general merchandising channels of trade are typically identified by unique control numbers, commonly referred to as a “stock keeping units” (SKUs). SKUs are often related to Universal Product Codes (UPCs) which are usually found on package in the form of a bar code over a number. Each SKU is unique and identifies a unique product. Thus, a 60 yard roll of tan masking tape will have an SKU. A 30 yard roll of the identical product will have a separate SKU. A package of two rolls of the 30 yard roll of tape will have a third unique SKU.

SKUs are used by many companies, including retailers, manufacturers and distributors, to specify products in transactions and to track products as they move from manufacturer to consumer. SKUs form an important part of the business records in many companies as they are used as a means of identifying products bought and sold, as a means of supporting invoices and shipping documentation, and as a means of tracking and analyzing sales, inventory and other business information through business analysis tools.

Conventionally, SKUs are used as identifying indicia in business management systems. Traditional business management techniques allow a business to determine the profitability and success of a SKU or group of SKUs representing a product or product/business line. However, conventional techniques do not provide information at a sub-SKU level. As a consequence, the ability to assess and manage various aspects of product research, development, and business activities is relatively limited. Thus, there is an unmet need for business management methods and/or systems that generates and leverages sub-SKU information to facilitate rendering business decisions.

### BRIEF DESCRIPTION

In one aspect, a business method manages items associated with a business entity. The business method is executed by a computing device and includes storing unique item identifiers, associating each identifier with at least one descriptor that further describes the item, tracking a performance of each item through the at least one descriptor, analyzing the tracked performance of the item, and rendering business decisions about the item based on the analysis. The at least one descriptor relates to a predetermined reason for introducing an item into a market, the reason including at least one of the following: to create a new product/business line; to offer a new item for sale; to create a line extension of an existing product line; to create a customer-specific line extension of an existing product line; to offer a promotional item; to create a display item; to change packaging for an existing product; to modify an existing item; to create a component item, and to create an international item.

Further scope of the applicability of the exemplary embodiments will become apparent from the detailed description provided below. It should be understood, however, that the detailed description and specific examples, while indicating exemplary embodiments, are given by way of illustration only, since various changes and modifications within the spirit and scope of the subsequent claims will become apparent to those skilled in the art.

### BRIEF DESCRIPTION OF THE DRAWINGS

The exemplary embodiments exists in the construction, arrangement, and combination of the various elements of the apparatus and/or elements of the method, whereby the difficulties contemplated above are overcome by the exemplary embodiments, as hereinafter more fully set forth in the detailed description, more specifically pointed out in the claims, and illustrated in the accompanying drawings in which:

FIG. 1 illustrates a business method for monitoring and analyzing item performance in order to manage various item related aspects;

FIG. 2 illustrates a flow chart for categorizing items to facilitate analyzing item performance and rendering business decisions based thereon;

FIG. 3 illustrates another business method for monitoring and analyzing item performance and managing item related aspects;

FIG. 4 illustrates an exemplary business system that employs the business methods described herein;

FIG. 5 illustrates an example of a report showing item performance delineated through item descriptive indicia;

FIG. 6 illustrates another example of a report showing item performance delineated through item descriptive indicia;

FIG. 7 illustrates yet another example of a report showing item performance delineated through item descriptive indicia; and

FIG. 8 illustrates still another example of a report showing item performance delineated through item descriptive indicia.

### DETAILED DESCRIPTION

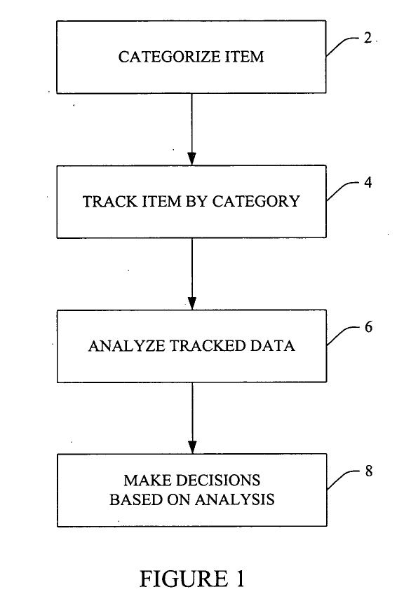

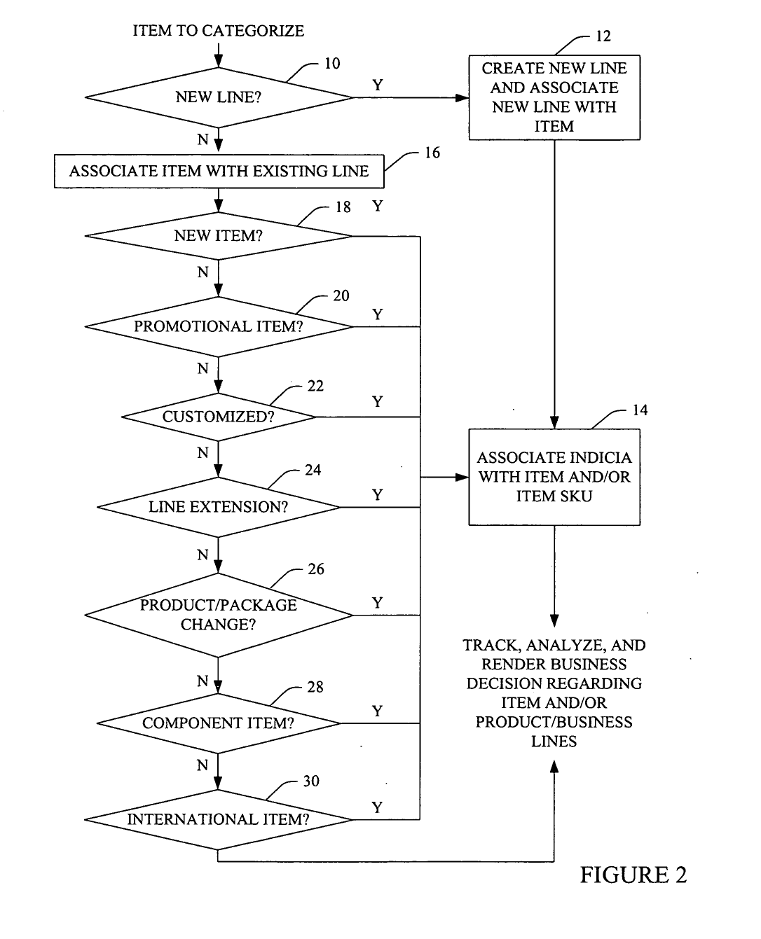

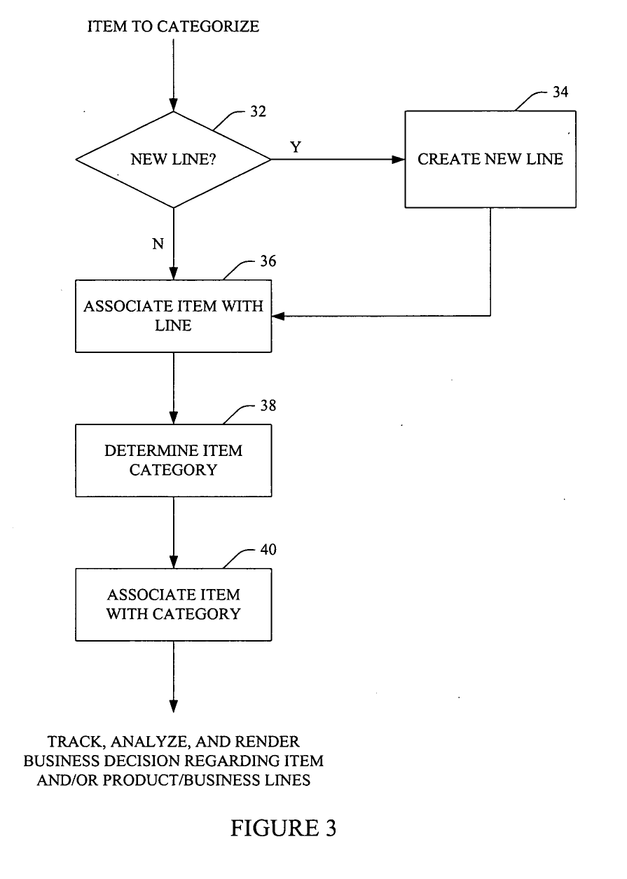

With reference to FIG. 1, a business method for monitoring and analyzing item (e.g., product) performance in order to manage various aspects of one or more items within and/or across product/business lines and/or the product/business lines is illustrated. Conventional techniques for tracking item performance typically track via SKUs and/or groups of SKUs. Such tracking provides a relatively coarse perspective of performance in the market at the SKU level. The novel business method illustrated in FIG. 1 (and FIGS. 2-3) delineates items within and/or across product/business lines via one or more categories, for example, by category descriptors or codes such as reason codes. This delineation provides for finer item tracking and analysis resolution within and/or across product/business lines.

At reference numeral 2, an item is categorized and associated with its corresponding product/business line. Such categorization can include associating descriptive indicia, such as one or more codes, with the item based at least in part on the item's SKU and/or with the SKU of the item. The descriptive indicia can be further delineated into subcategories, for example, through multiple codes. In addition, the descriptive indicia for an item can change over time. For example, an item may be labeled as “new” when a new product/business line is introduced into the market. The item may retain this label for some predetermined amount of time. Upon lapse of the predetermined time and/or other reason, the descriptive indicia may be ignored, discarded, and/or changed. For instance, when the predetermined time expires, the descriptive indicia indicating the item is “new” can simply be ignored during the analysis (e.g., report generating) and/or the disassociated with the item. Likewise, descriptive indicia relating to any other reason can be ignored and/or disassociated with the item upon lapse of the predetermined time. In another instance, when the predetermined time expires, the item may no longer be considered “new,” but instead a “line extension” and/or other category. In this case, the descriptive indicia can be changed to reflect the appropriate categorization.

In some instances, the item is the lead or first item within a product/business line and, thus, a new product/business line is created. Typically, the lead item and the new product/business line are categorized as “new” for some defined period of time. Other items within this product/business line can also be labeled as “new” for the defined length of time if they meet qualifying criteria. Thus, a new product/business line may be associated with a plurality of items identified as “new.” Still other items may be associated with descriptive indicia signifying other categories or reasons such as, for example, to denote the item is a promotional item, a line extension, a customer-specified line extension, a component item, an international item, a display item, an item with a changed package, and a changed item.

At 4, the categorized items are tracked by authorized entities. Typically, item tracking includes recording information such as the quantity and/or cost of the raw materials used to produce the item, individual components of the item (e.g., a tape dispenser may include tape, a supporting dispenser, a package, etc.), items in inventory, the SKU of each item, item sales, the number of items purchased, items being shipped, etc. The recorded information typically includes the descriptive indicia and/or the corresponding product/business line. In some instance, tracking is achieved through manual entry of the data by one or more individuals entering the data into a readable storage medium. Additionally and/or alternatively, the data is automatically entered into the readable storage medium.

At reference numeral 6, the tracked information is analyzed. Such analysis can be performed as desired. For example, the data can be analyzed daily, weekly, monthly, quarterly, semi-annually, annually, over multiple years, and/or over the items life-time, by descriptive indicia, etc. The analysis can include variously grouping the data, based on the user's desires. For example, the data can be grouped by category in the aggregate across product/business lines and/or within product/business lines. The data, grouped or not, can be displayed in one or more lists, tables, graphs, charts, and the like, wherein the data can be compared against past performance, predetermined milestones, forecasts, etc. In addition, such data can be used to predict future performance. For such predictions, the data can be processed by various inference engines, machine learning algorithms, neural networks, classifiers, etc, that use probabilities, cost minimization, confidence intervals, statistics, heuristics, etc.

At 8, the results of the analysis can be used to render business decision regarding the item, the product/business line, other items within the product/business line, items within another product/business line, other product/business lines, obsolete product/business lines, items under research and development, etc., and facilitate assessing and managing item product research, development, and/or other business related activities. By way of example, the data for an item deemed as “promotional” can be analyzed to determine whether the item should remain a promotional item, evolve to a regularly offered item (e.g., and associated with another category), and/or be retired (e.g., discontinued), whether its price should change, whether inventory should increase or decrease, if at all, whether the packing and/or item should be modified, etc. Similar to data analysis, the decision making can be performed manually and/or automatically, including employing intelligence. For instance, in one aspect the user can visually inspect the results and render a business decision. In another instance, a computer program may compare the results against past performance, predetermined milestones, forecasts, etc. and suggest and/or render a business decision.

FIG. 2 illustrates a flow chart for categorizing items to facilitate analyzing item performance and rendering business decisions based thereon. As previously described, such categorization can be through codes or other indicia that delineate items within product/business lines and used to track item performance, including within and/or across product/business lines, with relatively finer granularity than conventional tracking techniques. It is to be appreciated that the acts described in connection with FIG. 2 are provided for illustrative purposes and do not limit the invention. For example, more or less acts and/or a different ordering of the acts are also contemplated, but not described in detail for sake of brevity and clarity.

Initially referring to reference numeral 10, it is determined whether an item is related to an existing product/business line. In many instances, this is determined through analyzing the product's SKU. However, it is to be understood that essentially any item-related information can additionally and/or alternatively be used to facilitate determining such. If a related product/business line does not exist, then at 12 a new product line is created, and the item is associated with the newly created product line. At 14, the item and/or item SKU is associated with indicia (e.g., a reason code) that indicates the item is a new item. If at 10 a related product/business line is located, then at 16 the item and/or item SKU is associated with its related product/business line.

At reference numeral 18, it is determined whether the item is a new item. Examples of reasons for deeming the item “new” include, but are not limited to, whether the item resolves a previously unmet consumer need; is fundamentally different from any currently marketed item; is associated wit a new technology; is associated with a patent, is associated with a pending patent item; has never been marketed before; creates a new demand; creates a new use; provides new functionality, is within a predefined time period (e.g., one year) corresponding to the introduction of a lead item in the product line, etc. It is to be understood that the foregoing examples are provided for explanatory purposes and do not limit the invention. More or less and/or similar or different criteria can be used in accordance with various embodiments of the invention. If at 18 it is determined that the item is a new item, then at 14, the item and/or item SKU is associated with indicia that indicates the item is a new item.

If at 18 it is determined that the item is not a new item, then at 20 it is determined whether the item is a promotional item. For example, it is determined whether the item is a display item, a clipstrip, a bonus pack, a side kick, and/or the like. It is to be understood that the foregoing examples are provided for explanatory purposes and do not limit the invention. More or less and/or similar or different criteria can be used in accordance with various embodiments of the invention. If at 20 it is determined that the item is a promotional item, then at 14, the item and/or item SKU is associated with indicia that indicates the item is a promotional item.

If at 20 it is determined that the item is not a promotional item, then at 22 it is determined whether the item is a customer-specified item. For example, it is determined whether the item is a branded item that typically cannot be sold to other customers, and/or whether the item is associated with a private label. It is to be understood that the foregoing examples are provided for explanatory purposes and do not limit the invention. More or less and/or similar or different criteria can be used in accordance with various embodiments of the invention. If at 22 it is determined that the item is a customer-specified item, then at 14, the item and/or item SKU is associated with indicia that indicates the item is a customer-specified item.

If at 22 it is determined that the item is not a customer-specified item, then at 24 it is determined whether the item is a line extension to an existing item. For example, it is determined whether the customer views the item as broadening the product line; whether a color associated with the item has changed; whether a pattern associated with the item has changed; whether the item is associated with different merchandising, and/or whether the corresponding SKU results in a net increase in SKY count. It is to be understood that the foregoing examples are provided for explanatory purposes and do not limit the invention. More or less and/or similar or different criteria can be used in accordance with various embodiments of the invention. If at 24 it is determined that the item is a line extension item, then at 14, the item and/or item SKU is associated with indicia that indicates the item is a line extension item.

If at 24 it is determined that the item is not a line extension, then at 26 it is determined whether the item is associated with a product and/or package change. For example, it is determined whether any change is related to logistics; inventory management improvements; a new packaging look; an innovative way to sell an existing item; a different package size; a different case pack, and/or a SKU that does not result in a different SKU count. It is to be understood that the foregoing examples are provided for explanatory purposes and do not limit the invention. More or less and/or similar or different criteria can be used in accordance with various embodiments of the invention. If at 26 it is determined that the item is associated with a product and/or package change, then at 14, the item and/or item SKU is associated with indicia that indicates the item is associated with a product and/or package change.

If at 26 it is determined that the item is not associated with a product and/or package change, then at 28 it is determined whether the item is a component item. For example, it is determined whether the item typically is combined with one or more other components (e.g., Racks, POP materials, etc.). It is to be understood that the foregoing example is provided for explanatory purposes and does not limit the invention. More or less and/or similar or different criteria can be used in accordance with various embodiments of the invention. If it is determined that the item is a component item, then at 14, the item and/or item SKU is associated with indicia that indicates the item is a component item.

If at 28 it is determined that the item is not a component item, then at 30 it is determined whether the item is an international item. For example, it is determined whether the item is an export only item. It is to be understood that the foregoing example is provided for explanatory purposes and does not limit the invention. More or less and/or similar or different criteria can be used in accordance with various embodiments of the invention. If it is determined that the item is an international item, then at 14, the item and/or item SKU is associated with indicia that indicates the item is an international item. If at 30 it is determined that the item is not an international item, then the item is not associated with any further categorizing indicia.

As noted above, the particular acts and/or the order of the acts described are for illustrative purposes and do not limit the invention. In other embodiments, more or less acts and/or a different ordering of the acts are contemplated.

Items associated with descriptive indicia and/or the items without such indicia are monitored for performance, wherein the performance of an item is used to render business decision about the item. The monitoring and decision making can include tracking, analysis, and/or decision making as described in detail connection with FIG. 1. For example, the items can be tracked by category indicia within and/or across product/business lines, wherein the tracked information can be variously presented and/or compared with other data. Based on the tracked information and/or comparisons, a business decision related to the item can be rendered.

FIG. 3 illustrates another approach for categorizing items. With this approach, an item can be associated with more than one category through descriptive indicia. At reference numeral 32, it is determined whether an item is associated with a new or an existing product/business line. If a related product/business line is not located, then at 34 a new product line is created, and the item is associated with the newly created product line at 36. If a related product/business line is located, then at 36 the item is associated with its related product/business line. At 38, it is determined whether or not the item is associated with one or more categories used to track items. For example, the item may be related to one or more of the categories or reasons described in connection with FIG. 2, including new, promotional, line extension, customer-specified line extension, component item, international item, display item, changed package, and changed item. At 40, if the item and/or item SKU is associated with one or more categories, the item is associated with the one or more related categories (e.g., through descriptive indicia like a reason code). The categorized items are then monitored as described herein through the categories across and/or within product/business lines.

The business methods described in connection with FIGS. 1-3 as well as variations thereof and/or other techniques can be programmed within computer readable instructions residing on computer readable medium and executed by one or more computing systems such as desktops, laptops, personal data assistants, workstations, mainframes, and the like. The computing systems can execute the business method described herein with data provided by a user through input devices such as a keyboard, a mouse, a digital pen, voice, etc., portable storage medium such as CD, DVD, optical disk, RAM, and the like, and/or one or more business systems and/or applications.

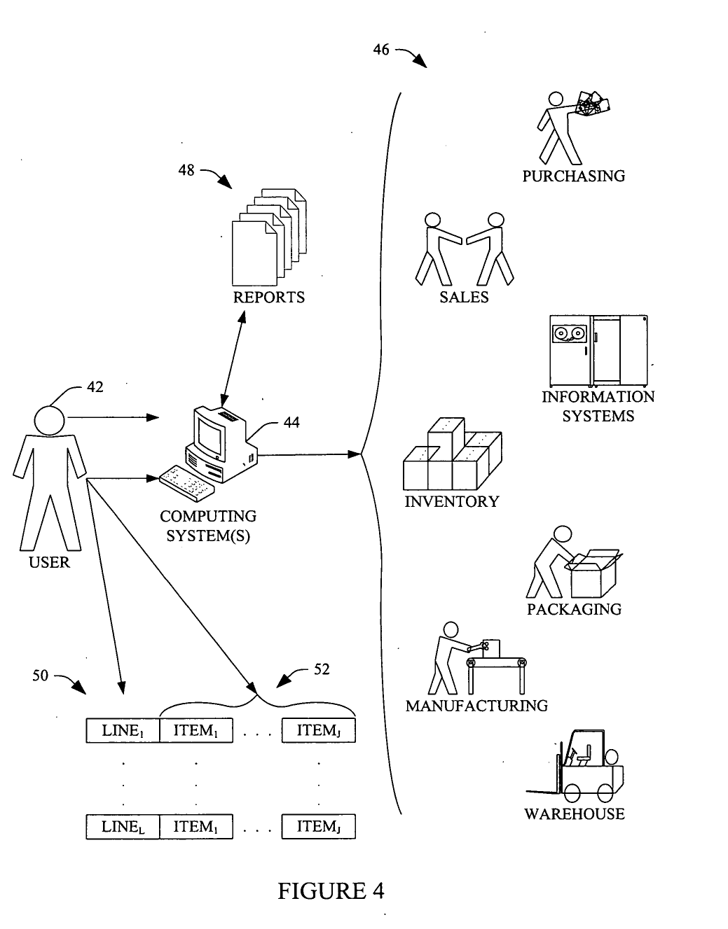

By way of example, FIG. 4 shows a user 42 interacting with one or more computing systems 44. The computing systems 44 can be associated through various ports (e.g., parallel, serial, Ethernet, USB, IR, etc.) and/or distributed over one or more networks (e.g., Wide Area Networks (WANs), Local Area Networks (LANs), etc.) via any known network topology. In addition, the computing systems 44 can be coupled to one or more business systems, departments, units, and/or applications 46. For instance, the computing systems 44 are depicted as communicating with purchasing, sales, manufacturing and/or packaging departments, various warehouses, inventory, and/or information systems such as Enterprise Resource Planning (ERP), Manufacturing Execution System (MES), Supervisory Control and Data Acquisition (SCADA) and/or Object Linking and Embedding (OLE) for Process Control (OPC) systems, databases, and/or servers.

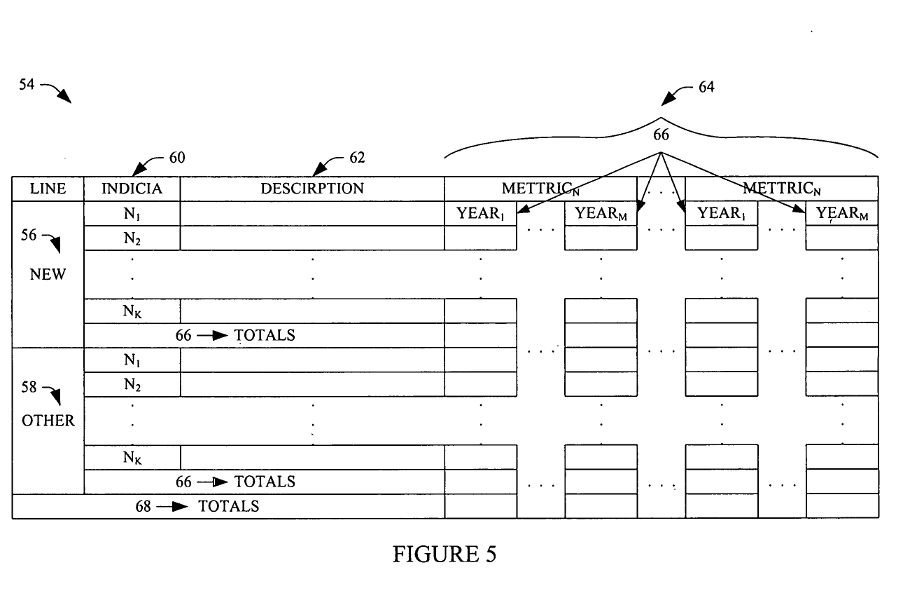

The computing systems 44 can be used to associate the descriptive indicia described herein with items from one or more product/business lines. The computing systems 44 also track item related information such as performance. As described previously, such tracking can be through item SKUs, the descriptive indicia, and/or item information. The computing systems 44 can process and/or analyze the tracking data and generate various reports 48, including aggregating data in lists, tables, graphs, charts, spreadsheets, etc., including those illustrated below with respect to FIGS. 5-8. The results can provide snapshots of performance over different time periods based on the descriptive indicia, be used to compare performance against past performance, predetermined milestones, forecasts, etc., and/or predict future performance. With this information, the user 42 and/or other authorized person(s) can make decision regarding one or more items 50 and/or product/business lines 52.

Briefly turning to FIG. 5, depicted is a non-limiting example illustrating item performance delineated through the item descriptive indicia described herein. A table 54 delineates item performance information for new product/business lines 56 and existing product/business lines 58 by descriptive indicia for multiple performance metrics, each parsed by year. The new and existing lines 56 and 58 are depicted as including multiple different category descriptors 60 with corresponding descriptions 62. The information associated with each of the category descriptors 60 is delineated across metrics 64, which are delineated over one or more defined years 66. The data within each of the metrics 64 can be analyzed on a yearly basis for each descriptor 60 and each of the new and existing lines 56 and 58 to provide rich item performance information at the category level with relatively fine granularity. This information can also be variously rolled up for higher level analysis. For instance, the category data within the descriptors 60 for each year 66 and each metric 64 can be rolled by new and existing line 56 and 58 as shown at 66. In another example, the category data within the descriptors 60 for each year 66 and each metric 64 can be rolled by to provide an aggregate total as shown at 68.

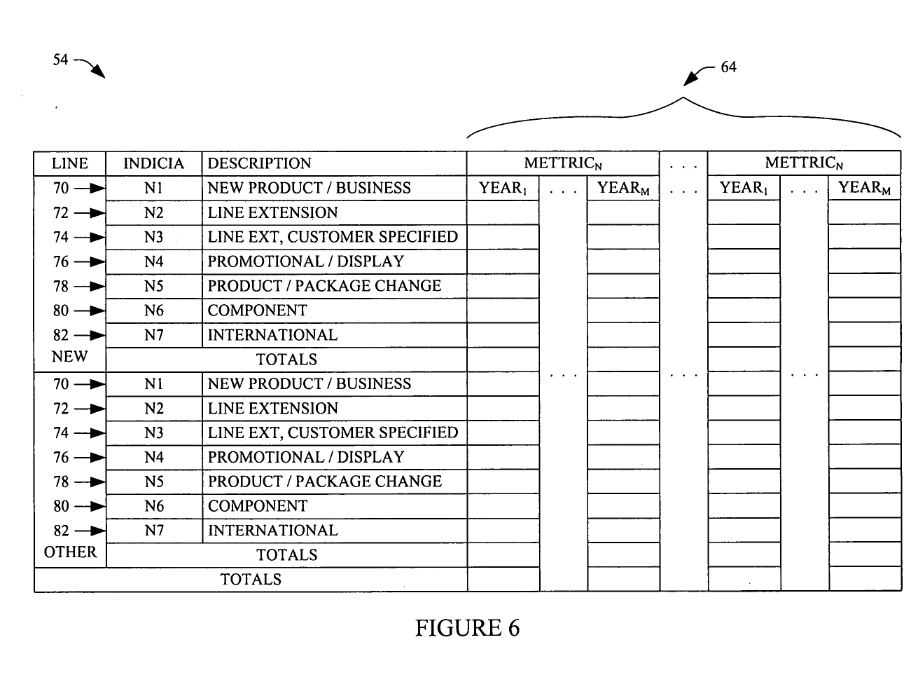

Turning briefly to FIG. 6, depicted is another non-limiting example illustrating item performance delineated through the item descriptive indicia. In this example, the table 54 includes the following category descriptors. At 70, a N1 descriptor for new product/business items; at 72, a N2 descriptor for line extensions; at 74, a N3 descriptor for customer-specified line-extensions; at 76, a N4 descriptor for promotional/display items; at 78, a N5 descriptor for a product/package changes; at 80, a N6 descriptor for component items; and, at 82, a N7 descriptor for a international items. It is to be understood that the foregoing descriptors do not limit the invention. In other embodiments, more or less and/or similar and/or different category descriptors can be used. In addition, any arbitrary symbol can be used to represent the category descriptors. Examples of suitable metrics 64 include, but are not limited to, gross shipments, profit margin, and scrap inventory, inventory dollars.

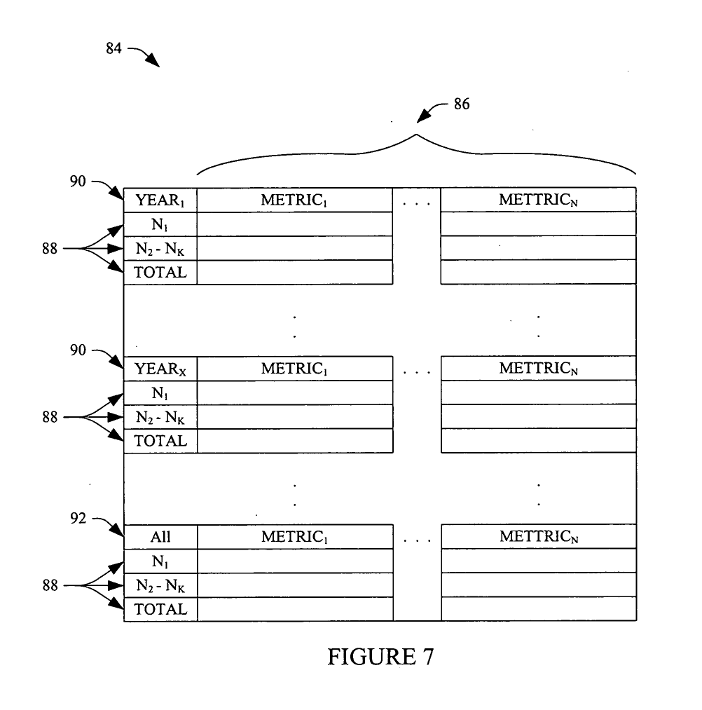

Turning to FIG. 7, illustrated is another non-limiting example of item performance data delineated by category descriptor. The table 84 delineates data across various metrics 86 for different groupings 88 of descriptive indicia for one or more years, individually 90 and in aggregate 92. Examples of suitable descriptors 88 include, but are not limited to, the descriptors 70-82 described in connection with FIG. 6 as well as other descriptors. Examples of suitable metrics 86 include, but are not limited to, gross shipments, profit margin, and scrap inventory, inventory dollars as a function of monetary units and/or as a percentage, SKU count, sales per SKU, and/or percent change. It is to be understood that the foregoing descriptors and metrics do not limit the invention.

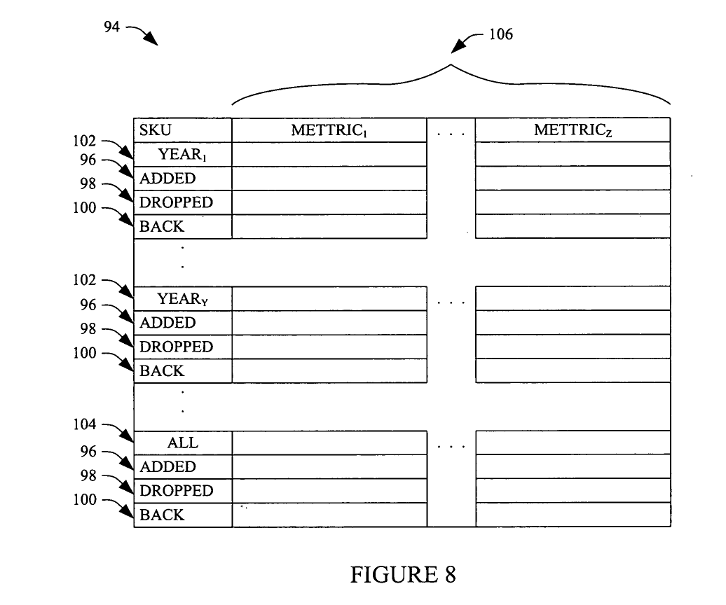

Turning to FIG. 8, illustrated is another non-limiting example of item performance data delineated by category descriptor. A table 94 provides SKU count related data. In particular, the table 94 includes fields for the number of added SKU's 96, dropped SKU's 98, and re-activated SKU's 100, which are presented for one or more years, individually 102 and rolled up 104, across one or more metrics 106. Examples of suitable metrics 106 include, but are not limited to, net sales, SKU count, one or more business unit identifiers, etc. as a function of monetary units and/or quantity.

Returning to FIG. 4, the category descriptors enable the tracked data to be variously separated and analyzed (e.g., through at least the example tables illustrated in FIGS. 5-8 described above) to render business decision regarding one or more of the items 50 and/or the product/business lines 52. Thus, a business manager can isolate the profitability and sales growth of a new product line and compare the new product line to the company's offerings as a whole to determine profitability and whether the new product line pricing is in line with the costs of producing the new product line. Moreover, the manager can determine if a customer specified line extension is having a negative or a positive impact on inventory control, a proper contribution to the profit margin, and other important measurements. The new products can be isolated by type, business group, new product introduction code, and/or other parameters. The profitability and other attributes applied to a particular business group's new products can be determined to better manage business. Measurements can be made and compared on a company, division, product line, or product basis.

A new product line SKU may be treated as a new product for three or so years or some other predetermined term. Thereafter, the new product is treated as an existing product. Thus, analysis seeking to measure profitability of new products is maintained as a valid state. The older innovations which are now part of the existing product line and not new products any longer drop off, for example, at their third anniversary. Only items assigned new product SKUs, for example, in the last three years form a portion of the new products group in a report processed from a business management system database.

Other products based upon this new product SKU may be introduced at a later time. For instance, if the product is successful, new sizes, new styles, or other variations of the product may be added. This may continue for several years. These new products may or may not be considered part of the new product line. One non-limiting approach to determining whether a new product is part of a new product line is to code products as line extensions or other category and group them with the new product SKUs that created the new line of products. These line extension SKUs may be treated as new products as long as the base SKU is treated as a new product or for a predetermined term.

The grouping strategy allows an innovation to be tracked, for example, for three years from introduction of the original new product. This allows variations of the original new product to be associated with the original new product. The grouped SKUs may be ignored or removed from the new product category for reporting purposes on, for example, the three year anniversary of the first new product SKU for the new line of products. This keeps the new product category true to its definition while maintaining the line extension categories for both new and existing products. This grouping strategy is implemented by making any SKU coded as a new product its own product line. Related products introduced within the first year may also be coded with similar indicia, but put in that same product line. Thereafter, new products related to the SKU are coded as line extensions, etc. and put into that product category. Thus, for example, a three year period as a new product line is maintained.

The business methods herein allow business managers to measure increased profitability from new products (SKUs) created through research and development and other new business processes. This profitability can be compared to the costs associated with the profitability. This allows an analysis of the return on the capital expended and whether the new products are being properly priced and whether the research and development and/or new business process are being properly managed. Moreover, the business methods described herein allows one to analyze the new product introduction process and the profitability of new products to levels of strategic business units, categories within business units, product groups, product lines, and individual products. The cost of developing new products can be compared with their increased profitability at each of these levels or in different groupings as desired. For instance, introduction of new products and the profitability of these new products can compared from one customer to another.

It is appreciated that certain aspects of the above-disclosed features and functions and/or alternatives thereof may be desirably combined into many other different, but related apparatus and/or methods. Also, various alternatives, modifications, variations, or improvements in the apparatus and/or methods may be subsequently made by those skilled in the art based on the disclosure provided herein. All such alternative, modifications, variations, and improvements as well as the exemplary embodiments disclosed herein are intended to be encompassed by the following claims.

1. A computed implemented method for managing items associated with a business entity, comprising:
storing a unique item identifier for an item in a computing component;
associating the stored unique item identifier with at least one descriptor that further describes the item;
tracking a performance of the item through the at least one descriptor;
analyzing the tracked performance; and
rendering a business decision about the item based on the analysis.

2. The computed implemented method as set forth in claim 1, wherein the at least one descriptor relates to a predetermined reason for introducing the item into a market, the reason including at least one of the following: to create a new product/business line; to offer a new item for sale; to create a line extension of an existing product line; to create a customer-specific line extension of an existing product line; to offer a promotional item; to create a display item; to change packaging for an existing product; to modify an existing item; to create a component item, and to create an international item.

3. The computed implemented method as set forth in claim 1, further including creating a new product/business line if the item is a lead item of the product line.

4. The computed implemented method as set forth in claim 1, further including, associating the stored unique item identifier with a related product/business line.

5. The computed implemented method as set forth in claim 4, wherein the related product/business line is one of an existing product/business line and a new product/business line.

6. The computed implemented method as set forth in claim 1, wherein the at least one descriptor associates the item with a predefined category for a predetermined period of time, and upon lapse of the predetermined period of time the at least one descriptor is ignored during analysis.

7. The computed implemented method as set forth in claim 1, further including a plurality of items that are associated with respective descriptors, wherein each descriptor indicates its associated item is a “new” item and each item is deemed “new” for a predetermined amount of time that is based on an introduction time frame of a lead item of a product/business line.

8. The computed implemented method as set forth in claim 1, wherein the at least one descriptor is associated with an item SKU.

9. The computed implemented method as set forth in claim 1, further comprising generating item reports for one or more of individual descriptors, different combinations of descriptors, and all descriptors.

10. The computed implemented method as set forth in claim 9, wherein the reports present the item related information across one or more metrics over a defined period.

11. The computed implemented method as set forth in claim 9, wherein the reports compare the item related information with at least one of past performance, predetermined milestones, and forecasts.

12. The computed implemented method as set forth in claim 9, wherein the reports provide SKU related information, including at least one of a number of SKUs added for one or more of the descriptors, a number of SKUs dropped for one or more of the descriptors, and a number of SKUs re-introduced for one or more of the descriptors.

13. The computed implemented method as set forth in claim 1, wherein the business decisions include at least one of the following: associating the stored unique item identifier with at different descriptor; setting a flag to ignore the descriptor during data analysis; discontinuing the item; changing a price of the item; adjusting an inventory of the item; adjusting an inventory one or more component parts of the item; modifying a packaging of the item; and modifying the item.

14. A computing system programmed to perform the method of claim 1.

15. A business method for managing items associated with a business entity, comprising:
determining whether a product is associated with an existing product line;
creating a new product line if the product is not associated with an existing product line;
associating a SKU of the product with the newly created product line and a descriptor that identifies at least one reason for the introduction of the product into a market;
monitoring a performance of the product through the descriptor; and
rendering a business decision about the product based on the performance.

16. The business method as set forth in claim 15, further comprising:
if a related existing product line exists, associating the SKU of the product with the existing product line;
determining whether the product is a new product, a promotional product, a display product, a customized product, a line extension, a component product, an international product, associated with a package change, or associated with a product change;
monitoring the performance of the product through the descriptor; and
rendering a business decision about the product based on the performance.

17. The business method as set forth in claim 15, further including analyzing the performance of the product based on the descriptor for a predetermined time, and upon lapse of the predetermined, ignoring the descriptor during said analysis.

18. The business method as set forth in claim 15, further including analyzing the performance of a plurality of products across and within product lines based on one or more descriptors.

19. The business method as set forth in claim 18, wherein the analysis includes comparing product data with at least one of past performance, predetermined milestones, and forecasts.

20. A business system that facilitates managing products, comprising:
a computing system, including:
a storage component that stores product related information; and
a receiving component that accepts product information provided by one or more of a user, a storage medium, and a business system;
said computing system associates a product SKU stored in the storage component with one of a newly created product line and an existing product line stored in the storage component, associates the product SKU with a descriptor that relates to a reason for introducing a corresponding product, the descriptor indicating the corresponding product is at least one of a new product, a promotional product, a display product, a customized product, a line extension, a component product, an international product, associated with a package change, or associated with a product change; acquires product performance data through the receiving component, and analyzes the product performance based on the descriptor.
